(19) United States
(12) Patent Application Publication
(10) Pub. No.: US 2021/0326302 A1
(43) Pub. Date: Oct. 21, 2021

(54) DETERMINING SHARED BLOCKS AMONG SNAPSHOTS IN A STORAGE SYSTEM

(71) Applicant: Hewlett Packard Enterprise Development LP, Houston, TX (US)

(72) Inventors: Anoop Kumar Raveendran, Bangalore Karnataka (IN); Hemanth Kancharla, Bangalore Karnataka (IN); Kiran Srinivas, Bangalore Karnataka (IN)

(21) Appl. No.: 17/249,302

(22) Filed: Feb. 26, 2021

(30) Foreign Application Priority Data
Apr. 15, 2020 (IN) 202041016226

(51) Int. Cl. G06F 16/16; G06F 16/14; G06F 16/18; G06F 16/11

(52) U.S. Cl. CPC G06F 16/162; G06F 16/113; G06F 16/1873; G06F 16/14

(57) ABSTRACT

Some examples relate to determine a shared block tracker at each snapshot of ‘n’ snapshots. The shared block tracker may represent a quantity of blocks that are shared among two or more snapshots. In a p^{th} shared block tracker, the block count mapped to a r^{th} snapshot identifier of a r^{th} snapshot may indicate how many of the blocks are shared among the p^{th} snapshot, the r^{th} snapshot and any intervening snapshot, where p and r, individually, indicate a snapshot in the ‘n’ snapshots, 1≤p≤n and 1≤r<p.

### BACKGROUND

With increase in data generation and data processing capabilities in enterprises, an ever-increasing amount of data are being produced which is stored for short, medium, or long periods. A large amount of data may be stored and managed by various users e.g., enterprises and individuals in storage systems using filesystems. A filesystem may further facilitate creation of snapshots, i.e., a point in time images of the filesystem. The snapshots can be used for various purposes, such as backup, creating a checkpoint for restoring the state of an application, a source for data mining.

### BRIEF DESCRIPTION OF THE DRAWINGS

For a more complete understanding of various examples, reference is now made to the following description taken in connection with the accompanying drawings, wherein:

FIG. 1 is a schematic block diagram of an example computing system that stores data and ‘n’ snapshot(s) of the data in a storage system;

FIGS. 2A-2C represent reference count values for blocks (a-j), a block-reference count map and a shared block tracker while creating a snapshot, in an example;

FIG. 3 depicts a series of shared block trackers at first, second and third snapshots, in an example;

FIG. 4 illustrates updating shared block trackers in response of deleting a snapshot, in an example;

FIG. 5 is a block diagram depicting a processor and a machine-readable storage medium encoded with example instructions to determine a shared block tracker at a snapshot;

FIG. 6 is flowchart of a method for determining a shared block tracker at a snapshot, in accordance with an example; and

FIG. 7 is flowchart of a method for determining a shared block tracker at a snapshot, in accordance with another example.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two as or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise.

Generally, data is stored in a storage system and managed through a filesystem. The filesystem may be understood as an abstraction for storing and managing data in a storage system, as data files. On storing data, a space or a volume (i.e., a quantity of blocks) in the storage system may be consumed by (or allocated to) the data. In other words, the data may occupy the blocks in the storage system. As used herein, the term “block” may refer to a unit of space for storing data in a storage system. Moreover, managing data may involve performing transactions, which may cause a change or a modification in at least a portion of the data. A transaction may be defined as an update action such as a write action or a delete action performed on the storage system to create, modify or delete at least a portion of data in response of an update request by a user or an administrator. For example, writing data onto the blocks of the storage system may be referred to as a transaction.

The filesystem may facilitate in controlling the manner in which data is stored, modified, and retrieved from the storage system. In addition, the filesystem may also facilitate in recording snapshots i.e., point in time images of the filesystem. A snapshot may be a copy or an image of a version (i.e., previous version) of a filesystem at a time stamp. In an example, a snapshot may be a copy or an image of the state of individual objects of a filesystem e.g., data files, directories etc. Accordingly, the snapshots of a filesystem may include various snapshots of data over a period of time. As used herein, a snapshot of a filesystem may include a snapshot of data in the filesystem.

The snapshots may be later used for creating a copy of the data managed by the filesystem. In some examples, the filesystem may use the snapshots for various data processing and storage purposes, such as backup, creating a checkpoint for restoring state of an application, data mining, and software debugging and testing. For instance, in case of a system crash or data getting corrupted, the snapshots can be used for restoring the data. The filesystem may create and maintain several snapshots to record the changes to the filesystem over a period of time. The snapshots so created may be saved on the storage system and occupy space (i.e., the blocks).

The filesystem may record the snapshots periodically after a predetermined time interval or each time a transaction is performed on the storage system. In an example, a snapshot may be created every time a transaction is performed i.e., a portion of the data is created, modified or deleted. The creation and deletion or unlinking of the snapshots may be recorded in a directory in the filesystem. In some examples, a snapshot may represent the changes in the data that occurred during the time interval between the time stamps of the snapshot and an immediately preceding snapshot. In such examples, each snapshot may account for two types of blocks: (i) block(s) that is exclusive to a snapshot i.e., the block(s) that is consumed only by the snapshot and (ii) block(s) that is shared among two or more versions of the data i.e., snapshots or a current version of the data in the storage system. Shared block(s) may refer to the block(s) that may be consumed (i.e., commonly consumed) by one or more versions (i.e., referrer version) of the data. In such instances, the block(s) may be shared (i.e., commonly consumed by) among two or more versions that are created in continuation (i.e., without any intervening version of the data that does not consume the block(s)). In this manner, one or more blocks at the storage system may be shared among various versions of the data, i.e., the current version of the data and the snapshots of the data, depending on the transactions performed.

Although snapshots may provide various benefits involving data processing and restoring previous versions of data, recording the snapshots may result in consumption of large amounts of space in the storage system. In some instances, it may also happen that few or no modifications may happen in the data when performing a transaction or within the periodic time interval between snapshots. In such a case, a snapshot may still be recorded even though the modifications on the base data are not significant. A later snapshot thus recorded would more or less be representative of the previously available snapshot. The later snapshot would however have to be stored. Over a period of time, the number of snapshots representing little or no modifications may be maintained in the storage system, which may unnecessarily occupy space (i.e., several blocks) in the storage system. As a result, when significant modifications occur, there may not be enough storage space available for accommodating the next snapshot. In some instances, some space (i.e., some of the blocks) in the storage system may be released and reclaimed (i.e., consumed by the updated data or new data). For example, the exclusive blocks (as discussed above) may be released (or freed) once a referrer version that consumes the blocks is purged and, the shared blocks may be released when all the referrer versions of the shared blocks are purged. However, with large amounts of data and multiple snapshots (e.g., hundreds of snapshots), it may be challenging and cumbersome to know how many snapshots are consuming an amount of space, which snapshot is consuming the most space or what is the space utilization by the snapshot(s).

The present subject matter presents systems and methods for tracking the blocks consumed by various versions of data i.e., snapshots and a current version of the data in a computing system. In particular, the described systems and methods may provide usage statistics of each block that is consumed by various versions. The usage statistics of a block may provide information about the referrer versions that consume the blocks, which may be helpful in estimating the amount of space (i.e., a quantity of blocks) that may be released for space utilization. This helps in achieving sufficient amount of space by purging less snapshots. In addition, the usage statistics may also help in tracking redundant snapshots, which may be purged. Redundant snapshots may refer to snapshots that consume same blocks i.e., all blocks are shared among two or more snapshots. In such instances, no change in the data may occur among two or more snapshots.

In particular, the described systems and methods determine a shared block tracker at each snapshot. The shared block tracker may represent a quantity of blocks that are shared between two or more snapshots. In addition, the shared block trackers may also represent a quantity of blocks (i.e., exclusive blocks) that are consumed by a single snapshot. These shared block trackers may be consistently stored using the filesystem, which enables tracking of the blocks online without filesystem downtime and no or minimal effect on the performance of the computing system. These shared block trackers at each snapshot may be helpful in determining how many blocks may be released for space utilization.

In an aspect, a computing system may be provided. The computing system may include a plurality of versions of data that consume a plurality of blocks in a storage system. The plurality of versions of the data may include a current version of the data and ‘n’ snapshots of the data, where ‘n’ indicates a quantity of snapshots of the data. Each snapshot of the ‘n’ snapshots may include a shared block tracker. In an example, a p^{th} shared block tracker of a p^{th} snapshot represents a block count mapped to a snapshot identifier of each snapshot created up to the creation of the p^{th} snapshot. In the p^{th} shared block tracker, the block count mapped to a r^{th} snapshot identifier of a r^{th} snapshot may indicate how many of the blocks are shared among the p^{th} snapshot, the r^{th} snapshot and any intervening snapshot. In some examples, a block count mapped to a p^{th} snapshot identifier of a p^{th} snapshot may indicate a quantity of blocks (i.e., exclusive blocks) that are consumed by the p^{th} snapshot. As used herein, p and r, individually, indicate a count of a snapshot in ‘n’ snapshots, where 1≤p≤n and 1≤r<p.

Some examples present a method for determining a shared block tracker at a snapshot while creating the snapshot. In an example, a n^{th} shared block tracker may be determined at a n^{th} snapshot while creating the n^{th} snapshot. As used herein, the term “while creating a snapshot” may mean that a shared block tracker may be determined while creating or immediately after the completion of the creation of a snapshot. In certain examples, the shared block tracker may be determined after creating the snapshot and before creating an immediate succeeding snapshot. In an example, the shared block tracker at a snapshot may be determined in a time interval between the creation time stamps of a snapshot and an immediate succeeding snapshot. Accordingly, the method determines a shared block tracker while or immediately after the creation a snapshot, which is the latest snapshot at that instant. The method for determining a shared block tracker at a snapshot may be facilitated by a filesystem that manages the storage system.

As used herein, a block count mapped to a snapshot in a shared block tracker may mean that the block count may be mapped to a snapshot identifier of the snapshot in the shared block tracker. The term “snapshot identifier”, as used herein, may refer to an identifier for a snapshot. In an example, the identifier may be alphabetical, numeric or a combination thereof that may be used for the identification of a snapshot. In an example, the snapshot identifiers for the ‘n’ snapshots may be used in accordance with the order of their creation depending on their creation time stamps. For example, the ‘n’ snapshots may be represented by snapshot identifiers S₁, S₂, . . . Sₙ (i.e., S₁-Sₙ), where the subscripts (1, 2, . . . n) indicate the order of their creation. For example, a 1^{st} snapshot represented by the snapshot identifier S₁ is created prior to a 2^{nd} snapshot represented by the snapshot identifier S₂, the 2^{nd} snapshot represented by the snapshot identifier S₂ may be created prior to a 3^{rd} snapshot represented by the snapshot identifier S₃ and so on. In such examples, no snapshot is created prior to the 1^{st} snapshot. Creation time stamp may refer to a time stamp of the creation of a snapshot in a storage system. Similarly, shared block trackers determined at each snapshot of the ‘n’ snapshots may be represented, respectively, by tracker identifiers T₁, T₂, . . . Tₙ (i.e., T₁-Tₙ).

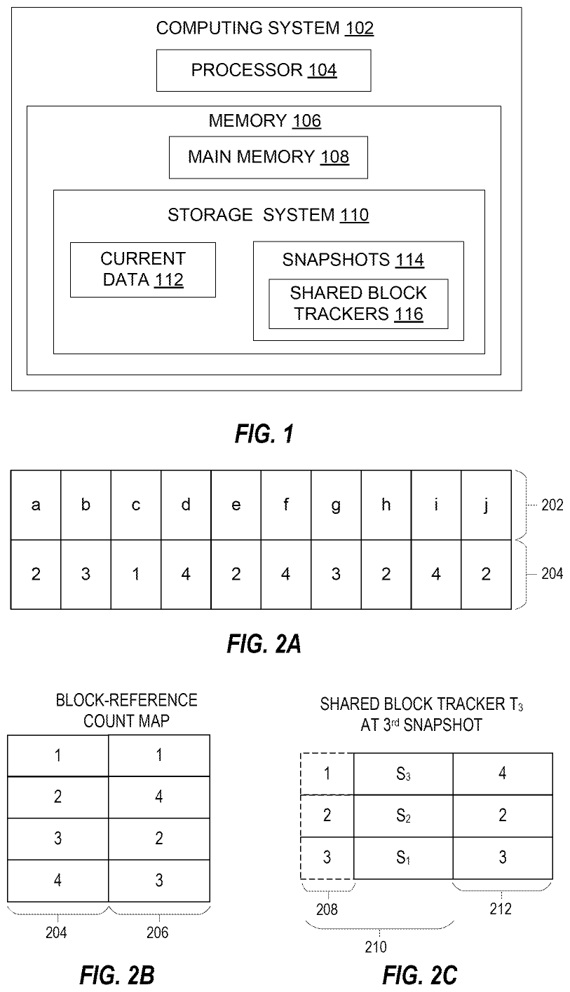

The above systems and methods are further described in conjunction with FIG. 1 to FIG. 7. It should be noted that the description and figures merely illustrate the principles of the present subject matter along with examples described herein and should not be construed as a limitation to the present subject matter. It will thus be appreciated that various arrangements that embody the principles of the present subject matter, although not explicitly described or shown herein, can be devised from the description and are included within its scope. Moreover, all statements herein reciting principles, aspects, and examples of the present subject matter, as well as specific examples thereof, are intended to encompass equivalents thereof.

FIG. 1 illustrates a block diagram of an example computing system 102, in accordance with an example of the present subject matter. The computing system 102 is hereinafter referred to as system 102. The system 102 may be implemented in, for example, servers, desktop computers, multiprocessor systems, personal digital assistants (PDAs), laptops, network computers, cloud servers, minicomputers, mainframe computers, hand-held devices (such as tablets), or storage systems. The system 102 may also be hosting a plurality of applications. The system 102 may further be implemented in a networked environment (not shown in the figure). In an example, the system 102 may be a part of a datacenter. As used herein, the term “server” may include a computer (e.g., hardware) that executes a computer program (machine-readable instructions) that may process requests from other (client) computers over a network.

The system 102 may include, for example, at least one processor 104 and a memory 106 communicatively coupled to the processor(s) 104. The processor(s) 104 may include a microprocessor, microcomputer, microcontroller, digital signal processor, central processing unit (CPU), state machine, logic circuitry, and/or any other device that manipulates signals and data based on computer-readable instructions. Further, functions of the various elements shown in the figures, including any functional blocks labeled as “processor(s)”, may be provided through the use of dedicated hardware as well as hardware capable of executing computer-readable instructions.

The memory 106 may be communicatively coupled to the processor(s) 104 and may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In one example, the memory 106 may include main memory 108 and a storage system 110. The storage system 110, such as hard disks and magnetic tapes may be used for storing data, such as data files in the system 102. The data stored in the storage system 110 may be managed, modified and retrieved through a filesystem (not shown). The main memory 108, such as RAM, may be used for temporary storage of the data for processing by the system 102.

In an example, data ‘D’ may be stored in the storage system 110. In some examples, the data ‘D’ may be updated multiple time in response of transactions performed over a period of time, and accordingly, may have a plurality of versions. The plurality of versions of the data ‘D’ may include a current version of the data ‘ID’ represented by current data 112 and ‘n’ snapshots 114, i.e., images of the previous versions of the data ‘D’, where n indicates a quantity of the snapshots of the data ‘D’ stored in the storage system 110. The filesystem may facilitate in recording (or creating) and managing the ‘n’ snapshots 114 of the previous versions of the data ‘D’ in the storage system 110. Recording and managing the snapshots e.g., the ‘n’ snapshots 114 may help in achieving efficient and smooth working of the system 102.

In an example, the current data 112 and the ‘n’ snapshots 114 of the data ‘D’ may consume a plurality of blocks in the storage system 110. That is, the plurality of blocks may be consumed by the plurality of versions of the data ‘D’ i.e., the current data 112 and the ‘n’ snapshots 114. Out of the plurality of blocks, one or more blocks may be shared i.e., commonly consumed, by two or more versions of the plurality of versions of the data ‘D.’ Such one or more blocks (i.e., shared blocks) may be shared among two or more versions of the data ‘D.’ In some examples, one or more blocks may be shared among two or more snapshots of the ‘n’ snapshots and may not be consumed by the current data 112.

In accordance to the present subject matter, each snapshot of the ‘n’ snapshots 114 may include a shared block tracker 116. Determining each shared block tracker 116 may be facilitated by the filesystem 120 while creating the respective snapshot 114. The shared block tracker 116 may indicate a quantity of shared blocks (indicated by block count) among two or more snapshots. In an example, a first shared block tracker (i.e., determined at 1^{st} snapshot) may indicate a quantity of exclusive blocks consumed by the 1^{st} snapshot. In the examples described herein, the shared block tracker 116 (e.g., p^{th} shared block tracker Tₚ) at a p^{th} snapshot may indicate how many of the blocks are shared among the p^{th} snapshot, the r^{th} snapshot and any intervening snapshot, where p and r, individually, indicate a snapshot in ‘n’ snapshots, 1≤p≤n and 1≤r<p. In some examples, the shared block tracker 116 may indicate exclusive blocks that may be consumed by a snapshot.

As described herein, a shared block tracker 116 (e.g., the p^{th} shared block tracker Tₚ) may be determined at a corresponding snapshot 114 (e.g., p^{th} snapshot) while creating the snapshot. That is, a shared block tracker 116 may be determined while creating the latest snapshot at an instant. In an example, the shared block tracker Tₚ may be determined when the p^{th} snapshot is created. In such instances, the p^{th} snapshot is the latest snapshot.

In the examples described herein, the system 102 may have ‘n’ snapshots. For the sake of simplicity, the below description is based on determining an n^{th} shared block tracker Tₙ at the n^{th} snapshot (i.e., the latest snapshot). At first, a reference count value may be retrieved for each block of the plurality of blocks that is consumed by the plurality of versions of the data, i.e., the current version of the data and ‘n’ snapshots of the data. A reference count value for a block may be a quantity of versions of the data D′ that consume that block. That is, the reference count value for a block may be a quantity of referrer versions of the block. In an example, a block may be consumed by at least one version of the data ‘D’ out of the plurality of versions. In an example, the block may be consumed by the current version of the data ‘D’ (i.e., the current data 112), at least a snapshot of the ‘n’ snapshots of the data ‘D’, or combinations thereof. Accordingly, a minimum value of the reference count value may be 1. In some examples, a block may be consumed by all the versions of the plurality of versions of the data ‘D’, i.e., the current data 112 and the ‘n’ snapshot(s). That is, a maximum value of the reference count value may be n+1. In the described examples, the reference count value may range from 1 to n+1. In some examples, information containing the reference count value for each block of the plurality of blocks may be retrieved from metadata of the filesystem 120. In an example, FIG. 2A shows reference count values 204 for each block of 10 example blocks (a-j) 202 that are consumed by at least one snapshot or a current version of data. In this example, the reference count value of block ‘a’ is 2, and the reference count value of block ‘g’ is 3. That is, block ‘a’ has 2 referrer versions of the data (e.g., 2 snapshots consume block ‘a’) and block ‘g’ has 3 referrer versions of the data (e.g., 3 snapshots consume block ‘g’).

On retrieving the reference count values for the blocks of the plurality of blocks, a block-reference count map may be determined. The block-reference count map may track a block count for each reference count value. The block count in the block-reference count map may indicate a quantity of blocks having a same reference count value. That is, the block count may indicate how many blocks have a same reference count value. In an example, the block-reference count map may be derived from the information containing the reference count value for each block of the plurality of blocks. For example, FIG. 2B shows an display diagram of a block-reference count map based on the information available in FIG. 2A. FIG. 2B shows block counts 206 for each reference count value 204. In FIG. 2A, block ‘b’ and block ‘g’ have the reference count value ‘3.’ Accordingly, a block count for the reference count value ‘3’ is 2. Similarly, a block count for the reference count value ‘2’ is 4, representing the four blocks with 2 reference counts, i.e., blocks ‘a’, ‘e’, ‘h’, and ‘j’.

For each reference count value, a principal referrer snapshot from the ‘n’ snapshots may be identified. A principal referrer snapshot for a reference count value may be a snapshot that consumes the block(s) (that are indicated by the block count corresponding to the reference count value in the block-reference count map)) for the first time. In other words, the principal referrer snapshot may be the first time the block(s) are consumed by a version of the data D′ in the system 102. That is, there may not be a snapshot that consumes the block(s) prior to the consumption of the block(s) by the principal referrer snapshot. In these instances, there may not be a snapshot that consumes the block(s) and is created prior to that of the principal referrer snapshot. In an example, there may be one or more snapshots that consume the block(s) and are created in continuation (i.e., without any intervening snapshot that does not consume the blocks) to the principal referrer snapshot.

In order to identify a principal referrer snapshot corresponding to each reference count in the block-reference count map, firstly the snapshot identifiers corresponding to ‘n’ snapshots may be sorted into sorted snapshot identifiers based on descending creation time stamps of the ‘n’ snapshots. In an example, the snapshot identifiers may be in ordered positions in the sorted snapshot identifiers. As noted previously, the ‘n’ snapshots may be represented using snapshot identifiers (S₁-Sₙ) for the snapshots in ascending order of their creation time stamps. In the examples described herein, the sorted snapshot identifiers may start with a snapshot identifier (i.e., latest snapshot identifier Sₙ) of the latest snapshot i.e., n^{th} snapshot followed by the snapshot identifiers (Sₙ₋₁, Sₙ₋₂, . . . S₁) corresponding to the snapshots in descending order of their creation time stamps. Accordingly, the latest snapshot identifier Sₙ may be at 1st position followed by Sₙ₋₁ at 2^{nd} position, Sₙ₋₂ at 3^{rd} position and so on in the sorted snapshot identifiers. Secondly, a snapshot corresponding to a q^{th} snapshot identifier from the sorted snapshot identifiers may be identified as a principal referrer snapshot corresponding to a reference count value ‘m’ such that m=q+1, where m is a reference count value and q indicates a position of a snapshot identifier in the sorted snapshot identifiers. In the examples described herein, q may vary from 1 to n. Accordingly, m may range from 2 to n+1. The snapshot identifier corresponding to the principal referrer snapshot may be referred to as principal referrer snapshot identifier. As an example, for a reference count value ‘3’ (i.e., m=3), q=2. In this example, a snapshot corresponding to a snapshot identifier at 2^{nd} position in the sorted snapshot identifiers may be the principal referrer snapshot corresponding to the reference count value ‘3.’.

In some example, a reference count value of block(s) may be 1. A reference count value ‘1’ for the block(s) may mean that the block(s) have only one referrer version of the data ‘D’ i.e., the latest snapshot. In an instance, the latest snapshot is the n^{th} snapshot. In such examples, the block(s) are exclusive to the latest snapshot and may be released by purging the latest snapshot (e.g., the n^{th} snapshot). Such information of exclusive block(s) may further be added in the shared block tracker 116; however, it may be avoided for the sake of simplicity. In examples where a transaction is performed and a snapshot is created in response of a write action, the information of exclusive block(s) may be redundant.

In instances where a transaction may be performed in response to a delete request, i.e., a request to delete a part of the current data 112, the information of exclusive blocks corresponding to a reference count value ‘1’ may be included in the shared block tracker 116. Inclusion of the quantity of exclusive blocks in such scenarios may be helpful in estimating the amount of space that may be released on deletion of all the versions of the data. In these instances, the latest snapshot, i.e., n^{th} snapshot may be identified as the principal referrer snapshot corresponding to the reference count value ‘1.’

On identifying the principal referrer snapshots corresponding to each reference count value, the n^{th} shared block tracker Tₙ at the n^{th} snapshot may be determined by mapping the block counts from the block-reference count map to the respective principal referrer snapshot identifiers for each reference count value. As an example, for the reference count value ‘m’, a principal referrer snapshot identifier Sₚ of the identified principal referrer snapshot (i.e., p^{th} snapshot) may be mapped to the block count corresponding to the reference count value ‘m’ in the block-reference count map. The block count mapped to the snapshot identifier Sₚ in the shared block tracker Tₙ may indicate a quantity of the blocks that are shared among the n^{th} snapshot, the p^{th} snapshot and any intervening snapshot. Similarly, the shared block tracker Tₙ may present a quantity of shared blocks corresponding to each snapshot identifier that may be identified as the principal referrer snapshot identifier for the reference count values. In an example, the shared block tracker Tₙ may include snapshot identifiers of the sorted snapshot identifiers, which include the snapshot identifiers of the snapshots created up to the creation of the n^{th} snapshot.

FIG. 2C depicts an example shared block tracker T₃ determined at 3^{rd} snapshot based on information of FIG. 2A and FIG. 2B, in an example. The shared block tracker T₃ is determined by mapping the block count 206 corresponding to each reference count value 204 in the block-reference count map of FIG. 2B with the corresponding principal referrer snapshot identifier in the sorted snapshot identifiers (S₃-S₁) 210. The positions of the snapshots (S₃-S₁) is shown in column 208. Each block count 206 mapped to a snapshot identifier in the shared block tracker T₃, may indicate the quantity of shared blocks 212. For reference count value ‘4’ in 204 of FIG. 2B, the principal referrer snapshot identifier is a snapshot identifier (i.e., S₁) that is at 3rd position (q=m−1) in the sorted snapshot identifiers 210. Accordingly, the corresponding block count ‘3’ (from 206) is mapped, in shared blocks 212, to snapshot identifier S₁ in FIG. 2C. This means that there are 3 shared blocks between 1^{st} snapshot, 2^{nd} snapshot and 3^{rd} snapshot. For reference count value 3 in 204 of FIG. 2B, the principal referrer snapshot identifier is a snapshot identifier (i.e., S₂) that is at 2nd position (q=m−1) in the sorted snapshot identifiers 210. Accordingly, the corresponding block count ‘2’ (from 2106) is mapped, in shared blocks 212, to snapshot identifier S₂ in FIG. 2C. This means that there are 2 shared blocks between 2^{nd} snapshot and 3^{rd} snapshot.

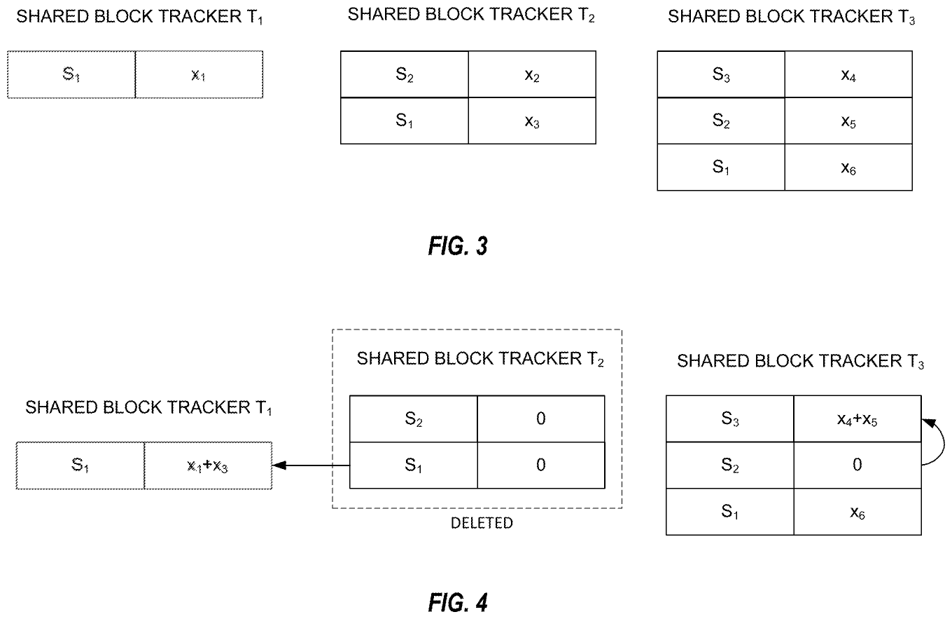

As described in the examples herein, a shared block tracker may be determined at each snapshot while the snapshot is created or after the creation of the snapshot and before creation of next immediate snapshot. FIG. 3 shows example display diagrams of three shared block trackers T₁, T₂, and T₃ at 1^{st}, 2^{nd}, and 3^{rd} snapshots. In the shared block trackers T₁, T₂, and T₃, x₁, x₂, . . . x₆ show the block count (i.e., quantity of blocks) corresponding to the respective snapshot identifiers S₁, S₂, and S₃. In this example, the block count x₁ indicates a quantity of exclusive blocks consumed by the 1^{st} snapshot, x₂ indicates a quantity of exclusive blocks consumed by the 2^{nd} snapshot, and x₄ indicates a quantity of exclusive blocks consumed by the 3^{nd} snapshot. Further, the block count x₃ indicates a quantity of blocks shared between the 1^{st} snapshot and the 2^{nd} snapshot, the block count x₅ indicates a quantity of blocks shared between the 2^{nd} snapshot and the 3^{rd} snapshot, and the block count x₆ indicates a quantity of blocks shared among the 1^{st} snapshot, the 2^{nd} snapshot and 3^{rd} snapshot.

In some examples, a p^{th} snapshot of the ‘n’ snapshots may be deleted e.g., for releasing the exclusive block(s). In these examples, a (p−1)^{th} shared block tracker Tₚ₋₁ at a (p−1)^{th} snapshot, a (p+1)^{th} shared block tracker Tₚ₊₁ at a (p+1)^{th} snapshot or both the shared block tracker Tₚ₋₁ and the shared block tracker Tₚ₊₁ may be updated in response of the deletion of the shared block tracker Tₚ at the p^{th} snapshot. In such instances, the block(s) referred by the block count corresponding to the snapshot identifier Sₚ in the shared block tracker Tₚ may be exclusive blocks that may be released on deletion of the p^{th} snapshot. In an example, updating the shared block tracker Tₚ₋₁ may include adding the block count (i.e., a quantity of shared blocks) corresponding to a snapshot identifier Sᵣ of a r^{th} snapshot from a shared block tracker Tₚ at the p^{th} snapshot to the block count corresponding to the snapshot identifier Sᵣ of the shared block tracker Tₚ₋₁, where r indicates a snapshot in the ‘n’ snapshots, and 1≤r<p. Further, updating the shared block tracker Tₚ₊₁ may include adding the block count (shared between the p^{th} snapshot and (p+1)^{th} snapshot) corresponding to the snapshot identifier Sₚ from the shared block tracker Tₚ₊₁ to the block count corresponding to snapshot identifier Sₚ₊₁ in the shared block tracker Tₚ₊₁.

For example, FIG. 4 illustrates updating shared block trackers T₁ and T₃ at the 1^{st} snapshot and the 3^{rd} snapshot (as shown in FIG. 3) in response of deleting the 2^{nd} snapshot. On deleting the 2^{nd} snapshot, the shared block tracker T₂ may be deleted. In such instances, the block count ‘x₃’ corresponding to snapshot identifier S₁ from the shared block tracker T₂ is added to the block count ‘x₁’ corresponding to snapshot identifier S₁ of the shared block tracker T₁. The blocks referred by the block count ‘x₂’ corresponding to snapshot identifier S₂ in the shared block tracker T₂ are released because of being exclusive blocks. Further, the block count ‘x₅’ (the quantity of blocks that are shared between 2^{nd} snapshot and 3^{rd} snapshot) corresponding to snapshot identifier S₂ from the shared block tracker T₃ is added to the block count ‘x₄’ corresponding to S₃ of the shared block tracker T₃.

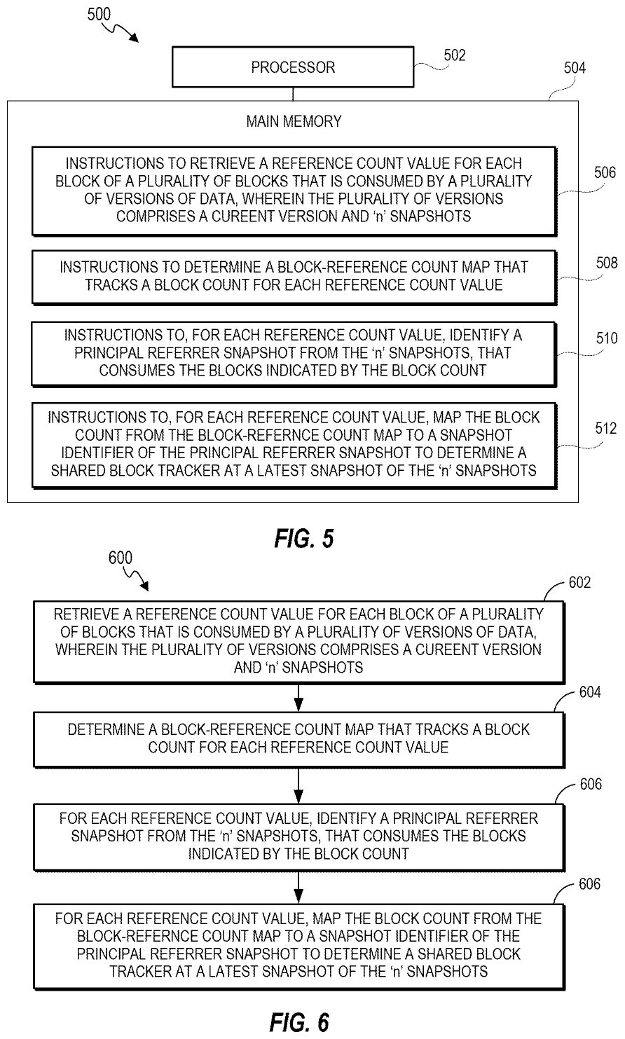

FIG. 5 is a block diagram 500 depicting a processor 502 and a machine readable medium 504 encoded with example instructions to determine a shared block tracker at a snapshot while creating the snapshot in a computing system such as the system 102 of FIG. 1, in accordance with an example. The machine readable medium 504 may be non-transitory and alternatively referred to as a non-transitory machine readable medium 504. In some examples, the machine readable medium 504 may be accessed by the processor 502. The processor 502 and the machine readable medium 504 may be included in a computing system such as the system 102 (FIG. 1). In an example, the machine readable medium 504 may be implemented in the main memory 108 of the system 102.

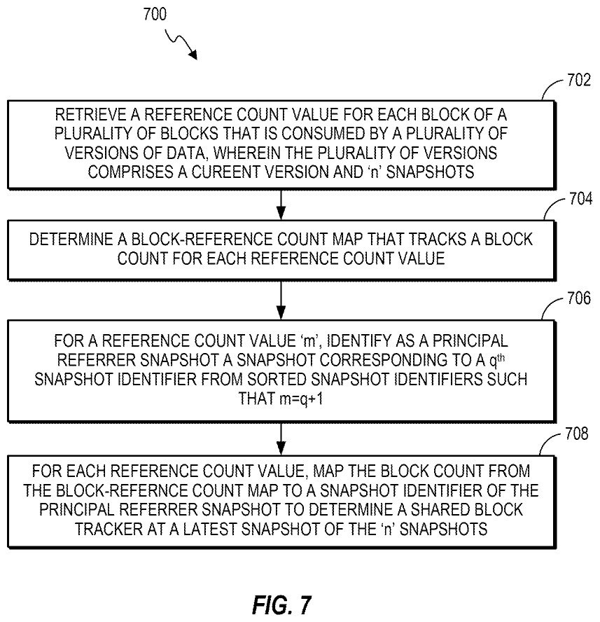

The machine readable medium 504 may be encoded with example instructions 506, 508, 510, and 512. The instructions 506, 508, 510, and 512 of FIG. 5, when executed by the processor 502, may implement various aspects of determining a shared block tracker. In particular, the instructions 506, 508, 510, and 512 of FIG. 5 may be useful for performing the functionalities facilitated by a filesystem of the storage system 110 and the methods described below with respect to FIGS. 6-7.

Non-limiting examples of the processor 502 may include a microcontroller, a microprocessor, central processing unit core(s), an application-specific integrated circuit (ASIC), a field programmable gate array (FPGA), etc. The machine readable medium 504 may be a non-transitory storage medium, examples of which include, but are not limited to, a random access memory (RAM), a read-only memory (ROM), an electrically erasable programmable read-only memory (EEPROM), a flash memory, a hard disk drive, etc. The processor 502 may execute instructions (i.e., programming or software code) stored on the machine readable medium 504. Additionally or alternatively, the processor 502 may include electronic circuitry for performing the functionalities described herein.

The instruction 506, when executed, may cause the processor 502 to retrieve a reference count value for each block of a plurality of blocks that is consumed by a plurality of versions of data “D′ stored in the storage system 110. The plurality of versions of the data ‘D’ may include a current version of the data (i.e. current data 112) and ‘n’ snapshots 114 of the data, where n indicates a quantity of snapshots of the data ‘D.’ Information related to the reference count values for the blocks of the plurality of blocks may be retrieved from metadata of the filesystem that manages the storage system 110. The instructions 508, when executed, may cause the processor 502 to determine a block-reference count map. The block reference count map may track a block count for each reference count value. The block count may indicate how many blocks have a same reference count value. The instructions 510, when executed, may cause the processor 502 to identify a principal referrer snapshot (described previously) for each reference count value. The principal referrer snapshot may refer to the block(s) indicated by the block count. The process of identifying the principal referrer snapshots for each reference count value is described with reference to FIGS. 1, 6 and 7. The instructions 512, when executed, may cause the processor 502 to map the block count from the block-reference count map to a snapshot identifier of the principal referrer snapshot for each reference count value to determine a shared block tracker. Each block count mapped to the snapshot identifier of the principal referrer snapshot may indicate a quantity of shared blocks among two or more snapshots. In the examples described herein, the block count mapped to a snapshot identifier in the shared block tracker indicates how many of the blocks are shared among the latest snapshot, the principal referrer snapshot and any intervening snapshot. In some examples, the instructions 506-512 may be executed every time a snapshot is created (i.e., while creating the latest snapshot) in the system 102 to determine a shared block tracker at each snapshot.

The instructions 506-512 may include various instructions to execute at least a part of the methods described in FIGS. 6-7 (described later). Also, although not shown in FIG. 5, the machine readable medium 504 may include additional program instructions to perform various other method blocks described in FIGS. 6-7.

FIGS. 6 and 7 depict flowcharts of example methods 600 and 700 for determining a shared block tracker at the latest snapshot (i.e., n^{th} snapshot of ‘n’ snapshots) while creating the latest snapshot a computing system, in accordance with various examples. For ease of illustration, the execution of methods 600 and 700 is described in details below with reference to FIG. 1. In an example, the execution of methods 600 and 700 is facilitated by the filesystem. Although the below description is described with reference to the computing system 102, other computing devices suitable for the execution of methods 600 and 700 may be utilized. In an example, the methods 600 and 700 are performed by the processor 104. Additionally, implementation of methods 600 and 700 is not limited to such examples. Although the flowcharts of FIGS. 6-7, individually, show a specific order of performance of certain functionalities, methods 600 and 700 are not limited to such order. For example, the functionalities shown in succession in the flowcharts may be performed in a different order, may be executed concurrently or with partial concurrence, or a combination thereof.

Referring now to FIG. 6, a flow diagram depicting a method 600 for determining a shared block tracker at a snapshot in a computing system, e.g., the system 102 (FIG. 1), is presented in accordance with an example. The method 600 will be described in conjunction with the system 102 of FIG. 1. As will be appreciated, method steps represented by blocks 602, 604, 606, and 608 (hereinafter collectively referred to as 602-608) may be performed by the processor 104. In some examples, the method at each method blocks 602-608 may be executed by the processor 502 by executing the instructions 504-512 stored in the machine readable medium 504.

At method block 602, the method 600 may include retrieving a reference count value for each block of the plurality of blocks that is consumed by the plurality of versions of the data ‘D’ stored in the storage system 110. The plurality of versions of the data ‘D’ may include a current version of the data ‘D’ and ‘n’ snapshots of the data ‘D’. In an example, the processor may retrieve the reference count value for each block of the plurality of blocks from metadata of the filesystem of the storage system 110. At method block 604, the method 600 may include determining a block-reference count map (e.g., FIG. 2) that tracks a block count for each reference count value. The block count may indicate how many blocks (i.e., a quantity of blocks) have a same reference count value. At method block 606, the method 600 may include identifying a principal referrer snapshot (described previously) from the ‘n’ snapshots for each reference count value. As described, the principal referrer snapshot for each reference count value may consume the blocks indicated by the corresponding block count in the block-reference count map, for the first time. At method block 608, the method 600 may include mapping the block count from the block-reference count map to a snapshot identifier of the principal referrer snapshot for each reference count value to determine a shared block tracker at the n^{th} snapshot. FIG. 2C shows an example of a shared block tracker T₃ determined at 3^{rd} snapshot. The block count mapped to the snapshot identifier (of the principal referred snapshot) in the shared block tracker indicates how many of the blocks (i.e., shared block(s)) are shared among the n^{th} snapshot, the principal referrer snapshot and any intervening snapshot.

Referring to FIG. 7 now, a flow diagram depicting a method 700 for determining a shared block tracker at a snapshot in a computing system e.g., the system 102 (FIG. 1) is presented, in accordance with an example. The method 700 is described in conjunction with FIG. 1. Further, the method 700 of FIG. 7 includes certain blocks that are similar to one or more blocks described in FIG. 6, details of which are not repeated herein for the sake of brevity. By way of example, the method blocks 702, 704, and 708 of FIG. 7 are similar to method blocks 602, 604, and 608 respectively, of FIG. 6. As will be appreciated, method steps represented by method blocks 702, 704, 706, and 708 (hereinafter collectively referred to as 702-708) may be performed by the processor 104. In some examples, the method at each method blocks 702-708 may be executed by the processor 502 by executing the instructions 504-512 stored in the machine readable medium 504.

At method block 702, the method 700 may include retrieving a reference count value for each block of the plurality of blocks that is consumed by the plurality of versions of the data ‘D’ stored in the storage system 110. In an example, the reference count value for each block of the plurality of blocks may be retrieved from metadata of the filesystem of the storage system 110. At method block 704, the method 700 may include determining a block-reference count map that tracks a block count for each reference count value. The block count may indicate a quantity of blocks having a same reference count value. At method block 706, the method 700 may include identifying as a principal referrer snapshot a snapshot corresponding to a q^{th} snapshot identifier from the sorted snapshot identifiers (described previously) for a reference count value ‘m’ such that m=q+1. The sorted snapshot identifiers may be achieved when the ‘n’ snapshots are sorted in descending order of their creation time stamps in an ordered position. An example of indexed snapshot identifiers 210 is shown in FIG. 2C. In some examples, a principal referrer snapshot may be identified for each reference count value in the block-reference count map. At method block 708, the method 700 may include mapping the block count from the block-reference count map to the snapshot identifier of the principal referrer snapshot for each reference count value to determine a shared block tracker Tₙ at the n^{th} snapshot. The block count mapped to a p^{th} snapshot (that is identified as the principal referrer snapshot corresponding to a reference count value) in the shared block tracker Tₙ may indicate how many of the blocks (i.e., a quantity of shared block(s)) are shared among the n^{th} snapshot, the p^{th} snapshot and any intervening snapshot.

In some examples, the methods 600 and 700 of FIGS. 6 and 7 may further include releasing at least one block of the plurality of blocks based on the shared block trackers at each of the ‘n’ snapshots. In an example, a shared block may be released by deleting two or more snapshots that share the block. In some examples, while performing a transaction in response of a delete response, the methods 600 and 700 of FIGS. 6 and 7 may include identifying, as the principal referrer snapshot, the latest snapshot, i.e., snapshot Sₙ corresponding to the reference count value ‘1.’ The block count corresponding to the reference count value ‘1’ may be mapped to the latest snapshot, i.e., n^{th} snapshot in the shared block tracker Tₙ to include exclusive block(s) consumed by the n^{th} snapshot.

In some examples where a p^{th} snapshot of the ‘n’ snapshots may be deleted, the method 700 as shown in FIG. 7 may include updating a shared block tracker Tₚ₋₁ of a (p−1)^{th} snapshot, updating a shared block tracker Tₚ₊₁ of a (p+1)^{th} snapshot or updating the shared block tracker Tₚ₋₁ and the shared block tracker Tₚ₊₁, in response of deleting the p^{th} snapshot. In such instances, the block(s) referred by the block count corresponding to the snapshot identifier Sₚ in the shared block tracker Tₚ may be exclusive blocks that may be released on deletion of the p^{th} snapshot. In an example, updating the shared block tracker Tₚ₋₁ may include adding the block count corresponding to a snapshot identifier Sᵣ of a r^{th} snapshot from a shared block tracker Tₚ at the p^{th} snapshot to the block count corresponding to the snapshot identifier Sᵣ of the shared block tracker Tₚ₋₁, where r indicates a snapshot in the ‘n’ snapshots, and 1≤r<p. Further, updating the shared block tracker Tₚ₊₁ may include adding the block count corresponding to the snapshot identifier Sₚ from the shared block tracker Tₚ₊₁ to the block count corresponding to snapshot identifier Sₚ₊₁ in the shared block tracker Tₚ₊₁.

It should be understood that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

I/We claim:

1. A method, comprising:
retrieving, by a file system of a storage device, a reference count value for each block of a plurality of blocks that is consumed by a plurality of versions of data stored in the storage device, wherein the plurality of versions of the data comprises a current version of the data and ‘n’ snapshots of the data, where n indicates a quantity of snapshots of the data;
determining a block-reference count map that tracks a block count for each reference count value, wherein the block count indicates how many blocks have a same reference count value;
for each reference count value, identifying a principal referrer snapshot from the ‘n’ snapshots, that consumes the blocks indicated by the block count; and
for each reference count value, mapping the block count from the block-reference count map to a snapshot identifier of the principal referrer snapshot to determine a (n^{th}) shared block tracker at a latest (n^{th}) snapshot of the ‘n’ snapshots, wherein the block count mapped to the snapshot identifier in the shared block tracker indicates how many of the blocks are shared among the (n^{th}) latest snapshot, the principal referrer snapshot and any intervening snapshot.

2. The method of claim 1, wherein each shared block tracker is determined in response of a transaction.

3. The method of claim 1, wherein the reference count value is retrieved from metadata of the file system.

4. The method of claim 1, wherein the identifying the principal referrer snapshot comprises:
sorting snapshot identifiers of the ‘n’ snapshots into sorted snapshot identifiers in descending order of creation time stamps; and
for a reference count value ‘m’, identifying as the principal referrer snapshot a snapshot corresponding to a q^{th} snapshot identifier from the sorted snapshot identifiers such that m=q+1, wherein ‘q’ indicates a position of the snapshot identifier in the sorted snapshot identifiers, m indicates a reference count value.

5. The method of claim 4, further comprising:
for a reference count value of 1, identifying as the principal referrer snapshot the latest (n^{th}) snapshot, when the shared block tracker is determined in response of a delete request.

6. The method of claim 1, further comprising:
in response of deleting a p^{th} snapshot comprising a p^{th} shared block tracker of the ‘n’ snapshots, wherein p indicates a count of a snapshot in the ‘n’ snapshots,
updating a (p−1)^{th} shared block tracker at a (p−1)^{th} snapshot, a (p+1)^{th} shared block tracker at a (p+1)^{th} snapshot or both the (p−1)^{th} shared block tracker and the (p+1)^{th} shared block tracker.

7. The method of claim 6, wherein updating the (p−1)^{th} shared block tracker comprises adding a block count mapped to a r^{th} snapshot identifier of a r^{th} snapshot from the p^{th} shared block tracker to a block count mapped to the r^{th} snapshot identifier in the (p−1)^{th} shared block tracker, where r indicates a snapshot in the ‘n’ snapshots, and 1≤r<p.

8. The method of claim 6, wherein updating the (p+1)^{th} shared block tracker comprises adding a block count mapped to a snapshot identifier Sₚ of the p^{th} snapshot from the (p+1)^{th} shared block tracker to a block count mapped to a (p+1)^{th} snapshot identifier of the (p+1)^{th} snapshot in the (p+1)^{th} shared block tracker.

9. A non-transitory machine-readable storage medium comprising instructions, the instructions executable by at least one processor to:
retrieve a reference count value for each block of a plurality of blocks that is consumed by a plurality of versions of data stored in a storage system, wherein the plurality of versions of the data comprises a current version of the data and ‘n’ snapshots of the data, where n indicates a quantity of snapshots of the data;
determine a block-reference count map that tracks a block count for each reference count value, wherein the block count indicates how many blocks have a same reference count value;
for each reference count value, identify a principal referrer snapshot from the ‘n’ snapshots, that consumes to the blocks indicated by the block count; and
for each reference count value, map the block count from the block-reference count map to a snapshot identifier of the principal referrer snapshot to determine a (n^{th}) shared block tracker at a latest (n^{th}) snapshot of the ‘n’ snapshot, wherein the block count mapped to the snapshot identifier in the shared block tracker indicates how many of the blocks are shared among the (n^{th}) snapshot, the principal referrer snapshot and any intervening snapshot.

10. The non-transitory machine-readable storage medium of claim 9, wherein the instructions to identify the principal referrer snapshot comprises instructions to:
sort snapshot identifiers of the ‘n’ snapshots into sorted snapshot identifiers in descending order of creation time stamps; and
for a reference count value ‘m’, identify as the principal referrer snapshot a snapshot corresponding to a q^{th} snapshot identifier from the sorted snapshot identifiers such that m=q+1, wherein ‘q’ indicates a position of the snapshot identifier in the sorted snapshot identifiers and m indicates a reference count value.

11. The non-transitory machine-readable storage medium of claim 10, wherein the instructions to identify the principal referrer snapshot comprises instructions to:
for a reference count value of 1, identify as the principal referrer snapshot the n^{th} snapshot, when the shared block tracker is determined in response of a delete request.

12. The non-transitory machine-readable storage medium of claim 11, wherein the instructions comprises instructions to:
in response of deleting a p^{th} snapshot comprising a p^{th} shared block tracker of the ‘n’ snapshots, wherein p indicates a count of a snapshot in the ‘n’ snapshots
update a (p−1)^{th} shared block tracker at a (p−1)^{th} snapshot, a (p+1)^{th} shared block tracker at a (p+1)^{th} snapshot or both the (p−1)^{th} shared block tracker and the (p+1)^{th} shared block tracker.

13. The non-transitory machine-readable storage medium of claim 12, wherein the instructions to update the (p−1)^{th} shared block tracker comprises instructions to add a block count mapped to a r^{th} snapshot identifier of a r^{th} snapshot from the p^{th} shared block tracker to a block count mapped to the r^{th} snapshot identifier in the (p−1)^{th} shared block tracker, where r indicates a snapshot in the ‘n’ snapshots, and 1≤r<p.

14. The non-transitory machine-readable storage medium of claim 12, wherein the instructions to update the (p+1)^{th} shared block tracker comprises instructions to add a block count mapped to a p^{th} snapshot identifier of the p^{th} snapshot from the (p+1)^{th} shared block tracker to a block count mapped to a (p+1)^{th} snapshot identifier of the (p+1)^{th} snapshot in the (p+1)^{th} shared block tracker.

15. A storage system, comprising:
a plurality of versions of data that consume a plurality of blocks of the storage device, wherein the plurality of versions of the data comprises a current version of the data and ‘n’ snapshots of the data, wherein n indicates a quantity of snapshots of the data; and
wherein each snapshot of the ‘n’ snapshots comprises a shared block tracker, wherein a p^{th} shared block tracker at a p^{th} snapshot represents a block count mapped to a snapshot identifier of each snapshot that is created up to the creation of the p^{th} snapshot, and
wherein the block count mapped to a r^{th} snapshot identifier of a r^{th} snapshot indicates how many of the blocks are shared among the p^{th} snapshot, the r^{th} snapshot and any intervening snapshot, where p and r, individually, indicate a snapshot in ‘n’ snapshots, 1≤p≤n and 1≤r<p.
